(19) United States
(12) Patent Application Publication
(10) Pub. No.: US 2024/0246538 A1
(43) Pub. Date: Jul. 25, 2024

(54) DISPLAY CONTROL DEVICE, COMPUTER READABLE STORAGE MEDIUM STORED WITH DISPLAY CONTROL PROGRAM, AND DISPLAY CONTROL METHOD

(71) Applicant: TOYOTA JIDOSHA KABUSHIKI KAISHA, Toyota-shi (JP)

(72) Inventor: Hideki TSUDA, Nagoya-shi (JP)

(73) Assignee: TOYOTA JIDOSHA KABUSHIKI KAISHA, Toyota-shi (JP)

(21) Appl. No.: 18/403,787

(22) Filed: Jan. 4, 2024

(30) Foreign Application Priority Data
Jan. 24, 2023 (JP) 2023-008673

(51) Int. Cl. B60W 30/16; B60R 1/24; B60R 11/02; B60R 11/04

(52) U.S. Cl. CPC B60W 30/162; B60R 1/24; B60R 11/0229; B60R 11/0264; B60R 11/04; B60R 2300/205; B60R 2300/301; B60R 2300/302

(57) ABSTRACT

A display control device that displays an image in a display area of a display unit showing a scene ahead of a vehicle or an image replicating the scene ahead. The display control device includes a detection section that detects a lead vehicle, and a display control section that, based on an acceleration or deceleration of a specific value or greater occurring in the vehicle due to following cruise control with the lead vehicle as a follow target, displays an image corresponding to acceleration or deceleration in the display area between the vehicle and the lead vehicle.

### CROSS-REFERENCE TO RELATED APPLICATION

This application is based on and claims priority under 35 USC § 119 from Japanese Patent Application No. 2023-008673 filed on Jan. 24, 2023, the disclosure of which is incorporated by reference herein.

### TECHNICAL FIELD

The present disclosure relates to a display control device, a computer readable storage medium stored with a display control program, and a display control method.

### RELATED ART

Technology has been proposed to achieve an improvement in a feeling of safety of a driver by displaying whether or not adaptive cruise control (ACC) is operating on a windshield of an automobile using an augmented reality-head up display (AR-HUD). For example, Japanese Patent Application Laid-Open (JP-A) No. 2019-148935 (Patent Document 1) discloses technology using an AR-HUD to display a line shaped image between a lead vehicle, which is the follow target during following cruise control under ACC, and an ego vehicle.

Generally, when AR display is constantly performed, there is a concern that a driver might experience annoyance due to always being displayed overlaid on a scene or on an image replicating the scene. In particular, an AR-HUD needs to display an image further upward on a windshield compared to a normal HUD in order to overlay display on a distant scene ahead, and so the problem mentioned above becomes even more significant.

### SUMMARY

In consideration of the above circumstances, an object of the present disclosure is to suppress annoyance due to continuing AR display particularly during following cruise control under ACC.

A first aspect is a display control device that displays an image in a display area of a display unit showing a scene ahead of a vehicle or an image replicating the scene ahead. The display control device includes a detection section that detects a lead vehicle, and a display control section that, based on an acceleration or deceleration of a specific value or greater occurring in the vehicle due to following cruise control with the lead vehicle as a follow target, displays an image corresponding to acceleration or deceleration between the vehicle and the lead vehicle. Note that deceleration means a negative acceleration, and a deceleration of a specific value or greater means a deceleration with an absolute value larger than the specific value.

In the first aspect, the display control device displays the image corresponding to acceleration or deceleration only when triggered by acceleration or deceleration of the specific value or greater occurring in the vehicle due to following cruise control, thereby enabling excessive display to be suppressed.

A second aspect is the display control device of the first aspect, wherein the display control section differs a display mode of the image corresponding to the acceleration or deceleration between cases of the vehicle accelerating and cases of the vehicle decelerating.

In the second aspect, a driver is able to intuitively ascertain that the vehicle is accelerating or decelerating due to following cruise control.

A third aspect is the display control device of the second aspect, wherein as the image corresponding to the acceleration or deceleration, the display control section displays a mark pointing at the lead vehicle in cases of the vehicle accelerating, and a mark pointing at the vehicle in cases of the vehicle decelerating.

In the third aspect, a driver is able to more intuitively ascertain that the vehicle is accelerating or decelerating due to following cruise control.

A fourth aspect is the display control device of the first aspect, wherein the display control section displays the image corresponding to the acceleration or deceleration prior to an actual acceleration or deceleration of the vehicle becoming the specific value or greater in cases in which an acceleration or deceleration is predicted to become the specific value or greater due to following cruise control.

In the fourth aspect, due to being able to notify an occupant prior to actual acceleration or deceleration of the vehicle, a unsettled feeling of the driver can be reduced.

A fifth aspect is the display control device of the first aspect, wherein the display control section changes a display mode of an image corresponding to acceleration or deceleration being displayed by the display control section in cases in which an acceleration or deceleration operation has been performed by a driver of the vehicle.

In the fifth aspect, that the vehicle is being accelerated or decelerated by operation of the driver can be notified to the driver due to the display mode being changed in cases in which the vehicle is accelerated or decelerated by operation of the driver. This thereby enables an unsettled feeling of the driver to be reduced.

A sixth aspect is the display control device of the first aspect, wherein the display control section does not perform display of an image corresponding to acceleration or deceleration in cases in which an acceleration or deceleration operation has been performed by a driver.

In the sixth aspect, excessive display can be suppressed due to not performing display in cases in which the vehicle is being accelerated or decelerated by the driver.

A seventh aspect is a computer-readable storage medium stored with a display control program to cause a computer to execute processing to display an image in a display area of a display unit showing a scene ahead of a vehicle or an image replicating the scene ahead. The processing includes processing to detect a lead vehicle, and processing that, based on an acceleration or deceleration of a specific value or greater occurring in the vehicle due to following cruise control with the lead vehicle as a follow target, displays an image corresponding to acceleration or deceleration in the display area between the vehicle and the lead vehicle.

In the seventh aspect, the display control program displays the image corresponding to acceleration or deceleration only when triggered by acceleration or deceleration of the specific value or greater occurring in the vehicle due to following cruise control, thereby enabling excessive display to be suppressed.

An eighth aspect is a display control method used by a computer to execute processing to display an image in a display area of a display unit showing a scene ahead of a vehicle or an image replicating the scene ahead. The processing includes processing to detect a lead vehicle, and processing that, based on an acceleration or deceleration of a specific value or greater occurring in the vehicle due to following cruise control with the lead vehicle as a follow target, displays an image corresponding to acceleration or deceleration in the display area between the vehicle and the lead vehicle.

In the eighth aspect, the display control method displays the image corresponding to acceleration or deceleration only when triggered by acceleration or deceleration of the specific value or greater occurring in the vehicle due to following cruise control, thereby enabling excessive display to be suppressed.

The present disclosure enables a driver to be notified that an acceleration or deceleration has occurred to a vehicle due to following cruise control while suppressing annoying display.

### BRIEF DESCRIPTION OF THE DRAWINGS

Exemplary embodiments of the present disclosure will be described in detail based on the following figures, wherein:

FIG. 1 is a schematic diagram illustrating a front section inside a vehicle cabin of a vehicle applied with a display control device according to an exemplary embodiment of the present disclosure, as viewed from a vehicle rear side;

FIG. 2 is a block diagram illustrating a hardware configuration of a display control system including a display control device according to an exemplary embodiment of the present disclosure;

FIG. 3 is a block diagram illustrating a functional configuration of a display control device according to an exemplary embodiment of the present disclosure;

FIG. 4 is a diagram illustrating an example of a display area according to an exemplary embodiment of the present disclosure;

FIG. 5 is a diagram illustrating an example of an image displayed by display processing during acceleration due to following cruise control;

FIG. 6 is a diagram illustrating an example of an image displayed by display processing during deceleration due to following cruise control;

FIG. 7 is a flowchart illustrating an example of a processing routine for executing display processing executed by an ECU;

FIG. 8 is a flowchart illustrating an example of a processing routine to end display processing executed by an ECU; and

FIG. 9 is diagram illustrating an example of display processing according to a second exemplary embodiment.

### DETAILED DESCRIPTION

Description follows regarding a display control device according to the present disclosure, with reference to the drawings. Examples are given below of configurations according to exemplary embodiments, and the technical scope of the invention should not be taken as being limited only to each of the configuration elements, the flowcharts, and the like.

### First Exemplary Embodiment

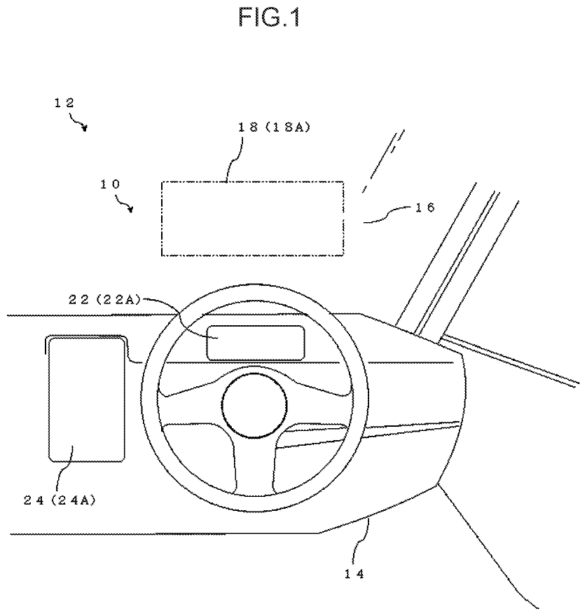

A vehicle 12 applied with a display control device 10 according to an exemplary embodiment of the present disclosure will now be described, with reference to FIG. 1.

As illustrated in FIG. 1, an instrument panel 14 is provided to a front section inside a vehicle cabin of the vehicle 12. The instrument panel 14 extends along the vehicle width direction, and a windshield glass 16 is provided at a front edge of the instrument panel 14. The windshield glass 16 extends toward a vehicle upper side from the front edge of the instrument panel 14, and partitions between the outside and the inside of the vehicle cabin of the vehicle 12.

A HUD projection surface 18 including a display area 18A is provided on the windshield glass 16 at a vehicle upper side of a meter display 22. The HUD projection surface 18 is a projection surface projected onto by a HUD device 20. More specifically, the HUD device 20 is provided at a vehicle front side of the instrument panel 14, and is configured such that an image from the HUD device 20 is projected onto the HUD projection surface 18 of the windshield glass 16.

The meter display 22 including a display area 22A is provided on the instrument panel 14. The meter display 22 is connected to various meter instruments installed to the vehicle 12, and is provided at a position entering a field of view in a state in which a driver is gazing in front of the vehicle.

A center display 24 including a display area 24A is provided to the instrument panel 14. The center display 24 is arranged at a vehicle width direction center portion of the instrument panel 14.

Hardware Configuration of Display Control System Including Display Control Device 10

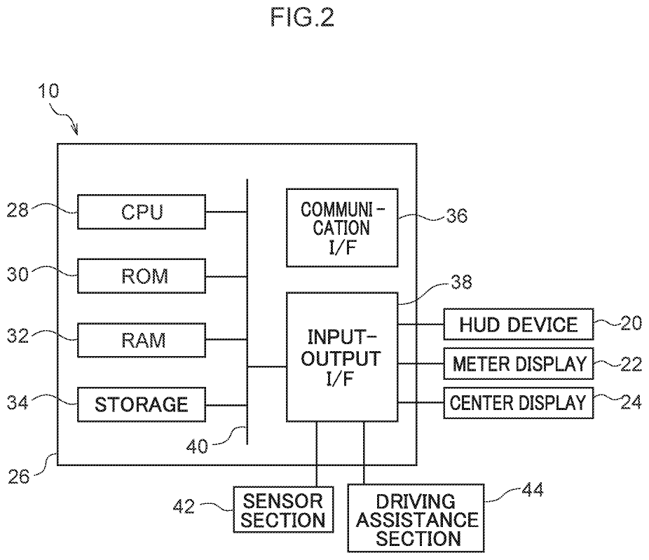

Description follows regarding a hardware configuration of a display control system including the display control device 10, with reference to FIG. 2. Note that the display control system is installed to the vehicle 12. The display control device 10 of the present exemplary embodiment is configured including an electronic control unit (ECU) 26. Note that although an example will be given in the present exemplary embodiment of an embodiment in which processing is performed by a single ECU, an embodiment may be adopted in which plural ECUs are provided, and processing is performed across the plural ECUs.

As illustrated in FIG. 2, the ECU 26 is configured including a central processing unit (CPU) 28, read only memory (ROM) 30, random access memory (RAM) 32, storage 34, a communication interface (communication I/F) 36, and an input-output interface (input-output I/F) 38. Each configuration is connected through a bus 40 so as to be capable of communicating with each other.

The CPU 28 is a central processing unit and executes various programs and controls each section. Namely, the CPU 28 reads a program from the ROM 30 or the storage 34, and executes the program using the RAM 32 as workspace.

The ROM 30 stores various programs and various data. The RAM 32 serves as workspace to temporarily store programs and/or data. The storage 34 is configured by a hard disk drive (HDD) or a solid state drive (SSD), and is stored with various programs including an operating system and various data. In the present exemplary embodiment, various programs and various data and the like for executing display processing are stored in the ROM 30 or the storage 34.

Note that each program may be provided in a format recorded on a non-transitory recording medium such as a compact disc read only memory (CD-ROM), a digital versatile disc read only memory (DVD-ROM), a universal serial bus (USB) memory, or the like. Each program may also be provided in a format downloadable from an external network through the communication I/F 36.

The communication I/F 36 is an interface for the display control device 10 to communicate with a non-illustrated server or other devices, and employs a standard such as, for example, Ethernet (registered trademark), LTE, FDDI, or Wi-Fi (registered trademark).

The HUD device 20, the meter display 22, a display unit of the center display 24, and a sensor section 42 are connected to the input-output I/F 38. An image is projected onto the HUD projection surface 18 by the HUD device 20.

The sensor section 42 is configured including various sensors, such as a camera, a millimeter radar, a light detection and ranging (LiDAR), a GPS sensor, a vehicle speed sensor, an acceleration sensor, an accelerator opening sensor, a brake pedal depression amount sensor, and the like.

In the vehicle 12, a driving assistance section 44 that executes plural driving assistance applications is provided so as to be able to communicate with the input-output I/F 38 or the sensor section 42, and performs computational processing based on plural sensor information. The driving assistance applications include, for example, collision avoidance control, ACC, and the like. The ECU 26 is able to acquire such driving assistance applications and sensor information through the input-output I/F 38.

The driving assistance section 44 includes a non-illustrated ACC switch, and a travel state of the vehicle 12 transitions to a state controlled by ACC by the ACC switch being operated by an occupant of the driver's seat, or the state controlled by ACC is released thereby. The ECU 26 is able to detect whether or not the vehicle 12 is controlled by ACC by an ACC control ON signal or an ACC control OFF signal being input from the ACC switch to the ECU 26.

### Functional Configuration of Display Control Device 10

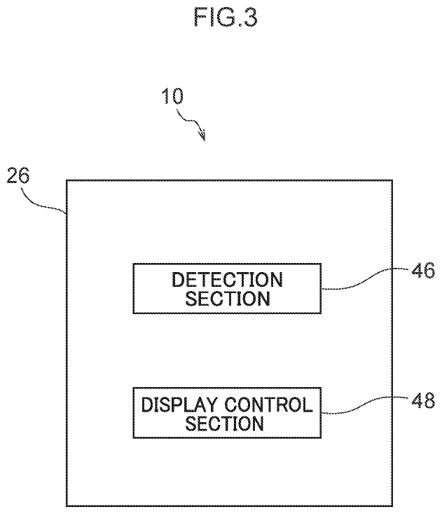

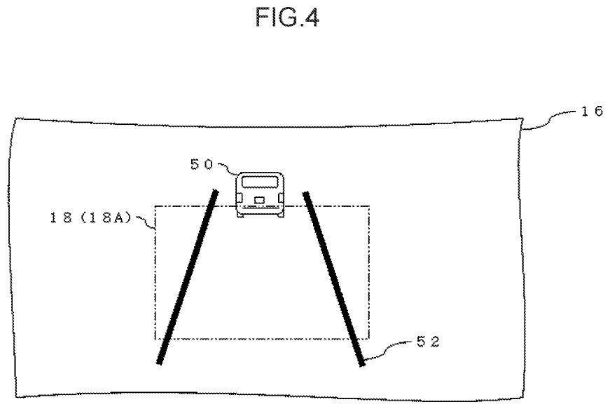

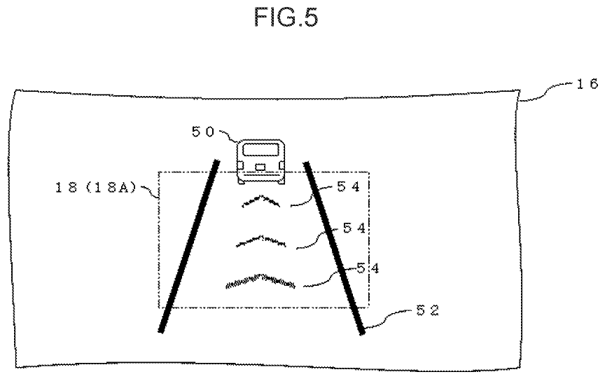

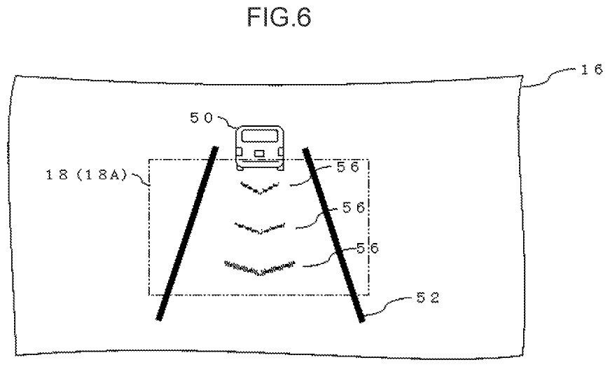

Description follows regarding a functional configuration of the display control device 10 implemented using the ECU 26, with reference to FIG. 3, FIG. 4, FIG. 5, and FIG. 6.

As illustrated in FIG. 3, the ECU 26 of the display control device 10, from a functional configuration perspective, is configured including a detection section 46, and a display control section 48. These functional configurations are configured so as to be able to exchange various information with each other. Each of the functional configurations is implemented by the CPU 28 reading and executing a program stored on the ROM 30 or the storage 34.

The detection section 46 detects output of the sensor section 42, and more specifically detects a lead vehicle 50 traveling ahead of the vehicle 12 based on camera images of a front camera. The front camera is, for example, a CCD camera or a CMOS camera, and is, for example, installed to a windshield center upper portion inside the ego vehicle cabin such that its optical axis coincides with the forward direction, and the front camera images in front of the ego vehicle so as to include the lead vehicle 50 and demarcation lines 52 (see FIG. 4). After image data has been subjected to known binarization processing and edge extraction processing, pattern matching is then performed thereon, and the lead vehicle 50 is pattern-recognized based on a model corresponding to a lead vehicle template.

In cases in which determination is made that the vehicle 12 is controlled by ACC based on the information from the driving assistance section 44, the display control section 48 determines whether or not following cruise control is being performed with the lead vehicle 50 detected by the detection section 46 as the follow target.

The display control section 48 generates an image to display on the HUD projection surface 18. The image generated by the display control section 48 includes, in addition to marks 54, 56 (see FIG. 5 and FIG. 6), for example, a meter image illustrating a meter display indicating a travel speed of the vehicle 12, and various images for the purpose of assisting manual driving and automated driving.

In cases in which the display control section 48 has determined that the vehicle 12 is performing following cruise control with the lead vehicle 50 as the follow target, information related to the following cruise control, more specifically the target acceleration of the vehicle 12, is acquired from the driving assistance section 44, and the display control section 48 determines whether or not an absolute value of the target acceleration is a specific value or greater.

The display control section 48 displays the mark 54 (see FIG. 5) between the lead vehicle 50 and the vehicle 12 when the absolute value of the target acceleration is the specific value or greater and the target acceleration is positive. The mark 54 is a mark of an arrow shape pointing in a direction of acceleration of the vehicle 12 (toward the lead vehicle 50). Note that the shape of the mark is not limited to the mark 54, and a mark of an arrow and chevron, or triangle shape may be employed as long as whichever direction is being indicated is clear. Various modifications to the shape are possible as long as a shape is employed that enables the driver to intuitively ascertain that the vehicle 12 is accelerating.

However, the display control section 48 displays the mark 56 (see FIG. 6) between the lead vehicle 50 and the vehicle 12 when the absolute value of the target acceleration is the specific value or greater and the target acceleration is negative. The mark 56 is a mark of an arrow shape pointing in a direction of deceleration of the vehicle 12 (toward the vehicle 12). Note that the shape of the mark is not limited to the mark 56, and a mark of an arrow and chevron, or triangle shape may be employed as long as whichever direction is being indicated is clear. Various modifications to the shape are possible as long as a shape is employed that enables the driver to intuitively ascertain that the vehicle 12 is decelerating.

The display control section 48 displays the mark 54 or the mark 56 corresponding to acceleration or deceleration only when triggered by acceleration or deceleration of the specific value or greater occurring in the vehicle 12 due to following cruise control, thereby enabling excessive display to be suppressed.

Next, the display control section 48 determines whether or not the driver has performed an acceleration or deceleration operation based on information from the sensor section 42. The display control section 48 ends display of the mark 54 or the mark 56 when determined that the driver has performed an acceleration or deceleration operation. Note that a display mode of the mark 54 or the mark 56 being displayed by the display control section may be a mode that changes when determined that the driver has performed an acceleration or deceleration operation. For example, a mode may be adopted in which the mark is made not to stand out by decreasing the brightness thereof or increasing the transparency thereof.

This thereby enables excessive display to be suppressed even more. Furthermore, an unsettled feeling of the driver can be reduced due to the driver being able to intuitively understand that the acceleration or deceleration is by operation of the driver and not acceleration or deceleration due to following cruise control.

Moreover, the display control section 48 acquires a target acceleration of the vehicle 12 from the driving assistance section 44, and ends display of the mark 54 or the mark 56 in cases in which the absolute value of the target acceleration is less than the specific value.

Note that in the present exemplary embodiment, modes of different brightness or color may be employed for the mark for cases in which the target acceleration is positive or negative. For example, a mode may be adopted in which the display control section 48 sets a color in a warm color series for the mark when the target acceleration is positive, and sets a color in a cold color series for the mark when the target acceleration is negative. Adopting such an approach enables the driver to understand more intuitively that the vehicle 12 is attempting to accelerate or decelerate.

### Processing Routine According to Display Processing

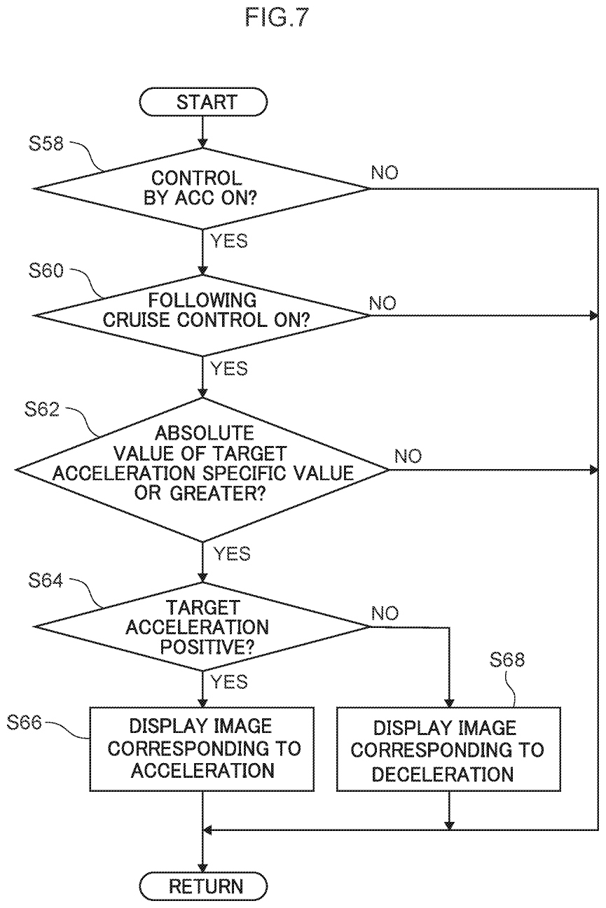

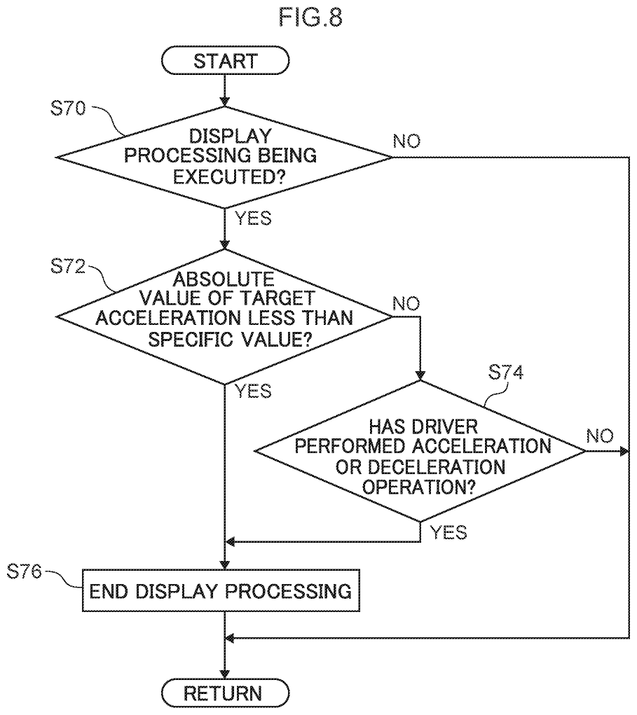

Description follows regarding an example of a processing routine according to display processing by the display control device 10 of the present exemplary embodiment, with respect to the flowcharts illustrated in FIG. 7 and FIG. 8. FIG. 7, is a flowchart illustrating an example of a processing routine to execute display processing executed by the ECU 26, FIG. 8 is flowchart illustrating an example of a processing routine to end display processing executed by the ECU 26. These processing routines are executed repeatedly every specific period of time.

At step S58 of FIG. 7 (“step” will be omitted hereafter), determination is made as to whether or not the vehicle 12 is controlled by ACC. The processing proceeds to S60 in cases in which affirmative determination is made at S58. However, the processing routine returns in cases in which negative determination is made at S58.

At S60, determination is made as to whether or not the vehicle 12 is due to following cruise control. Processing proceeds to S62 in cases in which affirmative determination is made at step S60. However, the processing routine returns in cases in which negative determination is made at S60.

At S62, determination is made as to whether or not the absolute value of the target acceleration due to following cruise control is the specific value or greater. Processing proceeds to S64 in cases in which affirmative determination is made at S62. However, the processing routine returns in cases in which negative determination is made at S62.

At S64, determination is made as to whether or not the target acceleration due to following cruise control is positive. Processing proceeds to S66 in cases in which affirmative determination is made at S64. At S66, display processing is performed to display an image corresponding to acceleration between the lead vehicle 50 and the vehicle 12. However, processing proceeds to S68 in cases in which negative determination is made at S64. At S68, display processing is performed to display an image corresponding to deceleration between the lead vehicle 50 and the vehicle 12. The processing routine returns when the processing of S66 or S68 has been executed.

At step S70 of FIG. 8 (hereafter “step” will be omitted), determination is made as to whether or not display processing is being executed. Processing proceeds to S72 in cases in which affirmative determination is made at S70. However, the processing routine returns in cases in which negative determination is made at S70.

At S72, determination is made as to whether or not the absolute value of the target acceleration is less than the specific value. Processing proceeds to S76 in cases in which affirmative determination is made at S72, and display processing is ended at S76. However, processing proceeds to S74 without ending display processing in cases in which negative determination is made at S72.

At S74, determination is made as to whether or not the driver has performed an acceleration operation. Processing proceeds to S76 in cases in which affirmative determination is made at S74, and display processing is ended at S76. The processing routine returns in cases in which negative determination is made at S74.

### Second Exemplary Embodiment

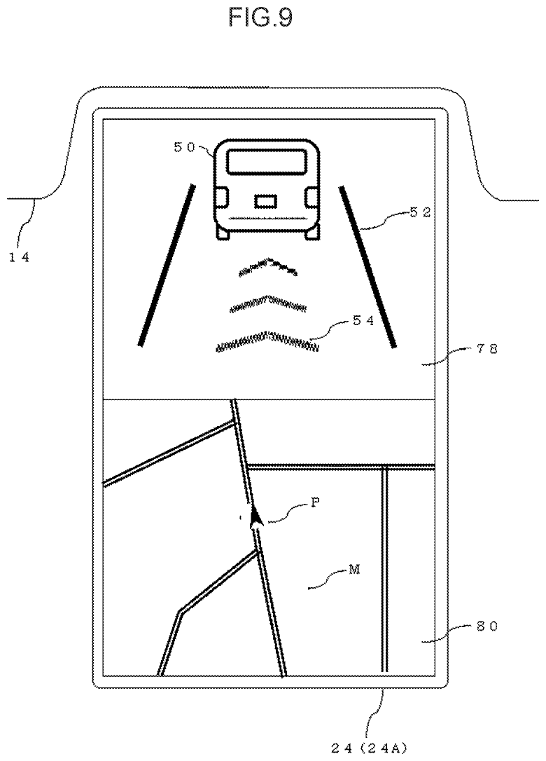

In the exemplary embodiment described above, a case was described in which the display area 18A is configured by the HUD projection surface 18, however the present disclosure is not limited thereto. A mark may be displayed on a display area of the center display 24 provided to the instrument panel 14, as in the second exemplary embodiment illustrated in FIG. 9.

As illustrated in FIG. 9, in the second exemplary embodiment a display area 24A of the center display 24 is divided into upper and lower sections. A scene ahead image illustrating a scene ahead of the vehicle 12 is displayed in an upper section 78 of the display area 24A, and a map image M indicating a current position P of the vehicle 12 is displayed in a lower section 80 of the display area 24A.

In the second exemplary embodiment, the mark 54 is displayed on the center display 24 provided to the instrument panel 14. Thus similarly to in the first exemplary embodiment, excessive display can be suppressed for occupants viewing the center display 24 irrespective of seated position, and an unsettled feeling of the occupants can be reduced.

### Third Exemplary Embodiment

In the third exemplary embodiment, an image captured with the front camera configuring the sensor section 42 is displayed together with the mark on a display area 22A of a meter display 22 provided at a vehicle front side of a driver's seat. The meter display 22 is provided at a vehicle front side of the driver's seat, enabling the driver in the driver's seat to view the meter display 22 without substantially moving gaze from a scene ahead of the vehicle.

### MODIFIED EXAMPLES

Note that in the exemplary embodiments described above, in cases in which the display control section 48 has predicted an absolute value of a target acceleration due to following cruise control to be a specific value or greater, an image corresponding to an acceleration or deceleration may be displayed prior to the absolute value of the actual acceleration of the vehicle 12 becoming the specific value or greater. Notification is thereby able to be made to the occupant prior to the vehicle actually accelerating or decelerating, enabling an unsettled feeling of the driver to be reduced further.

More specifically, the display control section 48 acquires a future target acceleration from the driving assistance section 44. The future target acceleration is computed by the driving assistance section 44 based on a relative speed between the vehicle and the lead vehicle 50 (computed based on a phase difference of transmitted waves and received waves of a millimeter radar), a current inter-vehicle distance, and a target inter-vehicle distance set by the driver. For example, in cases in which the current inter-vehicle distance is longer than the target inter-vehicle distance set by the driver, the future target acceleration is computed based on this difference and the current relative speed. Subsequently, in cases in which the display control section 48 has determined that the absolute value of the future target acceleration is the specific value or greater, an image corresponding to the acceleration or deceleration is displayed prior to the future target acceleration being transmitted from the driving assistance section 44 to an actuator of the vehicle 12.

Note that in the exemplary embodiments described above, the mark may be in a mode displayed so as to flow in the vehicle progression direction or an opposite direction thereto. For example, the display control section 48 may display a mark 54 in a mode so as to flow in a direction from the vehicle 12 toward the lead vehicle 50 when the target acceleration is positive, and may display a mark 56 so as to flow in a direction from the lead vehicle 50 toward the vehicle 12 when the target acceleration is negative. Adopting such an approach enables the driver to understand more intuitively whether or not the vehicle 12 is attempting to accelerate or decelerate.

Note that in the exemplary embodiments described above, the display control section 48 may display an image replicating a scene ahead on a display area of a display unit. For example, an image of a polygon replicating the lead vehicle 50 may be displayed on an image replicating a cruising lane defined by demarcation lines 52.

Note that in the exemplary embodiment described above, the display control section 48 acquires the target acceleration of the vehicle 12 from the driving assistance section 44, and a mode may be adopted in which the display of the mark 54 or the mark 56 is not ended and display is continued until a specific period of time has elapsed from the start of display even in cases in which the absolute value of the target acceleration is less than the specific value. Displaying the mark 54 or mark 56 that has started to be displayed by continuous display for a specific period of time enables a reduction in an unsettled feeling of the driver that would occur from displaying and then suddenly ending display.

Note that the various processing executed in the above exemplary embodiment by the CPU 28 reading and executing software (programs) may be executed by various processors other than a CPU. Examples of such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Moreover, each of the above processing may be executed by any one of these various types of processor, or may be executed by a combination of two or more of the same type or different types of processor (such as plural FPGAs, or a combination of a CPU and an FPGA). The hardware structure of these various types of processors is more specifically an electric circuit combining circuit elements such as semiconductor elements.

Although exemplary embodiments of the present disclosure have been described above, the present disclosure is not limited to the above exemplary embodiments, and various modifications may be made thereto. For example, the processing routines described in the above exemplary embodiments are merely examples thereof, and unnecessary steps may be removed, new steps may be added, and the processing sequence may be changed within a range not departing from the spirit thereof.

What is claimed is:

1. A display control device that displays an image in a display area of a display unit showing a scene ahead of a vehicle or an image replicating the scene ahead, the display control device comprising at least one processor, the at least one processor being configured to:
detect a lead vehicle; and
based on an acceleration or deceleration of a specific value or greater occurring in the vehicle due to following cruise control with the lead vehicle as a follow target, display an image corresponding to acceleration or deceleration in the display area between the vehicle and the lead vehicle.

2. The display control device of claim 1, wherein the at least one processor is configured to change a display mode of the image corresponding to the acceleration or deceleration between cases of the vehicle accelerating and cases of the vehicle decelerating.

3. The display control device of claim 2, wherein as the image corresponding to the acceleration or deceleration, the at least one processor is configured to display a mark pointing at the lead vehicle in cases of the vehicle accelerating, and a mark pointing at the vehicle in cases of the vehicle decelerating.

4. The display control device of claim 1, wherein the at least one processor is configured to display the image corresponding to the acceleration or deceleration prior to an actual acceleration or deceleration of the vehicle becoming the specific value or greater in cases in which an acceleration or deceleration is predicted to become the specific value or greater due to following cruise control.

5. The display control device of claim 1, wherein the at least one processor is configured to change a display mode of an image corresponding to acceleration or deceleration being displayed in cases in which an acceleration or deceleration operation has been performed by a driver of the vehicle.

6. A display control device of claim 1, wherein the at least one processor is configured to not perform display of an image corresponding to acceleration or deceleration in cases in which an acceleration or deceleration operation has been performed by a driver.

7. A non-transitory computer-readable storage medium storing a display control program that is executable by a computer to perform processing to display an image in a display area of a display unit showing a scene ahead of a vehicle or an image replicating the scene ahead, the processing comprising:
detecting a lead vehicle traveling ahead of the vehicle; and
based on an acceleration or deceleration of a specific value or greater occurring in the vehicle due to following cruise control with the lead vehicle as a follow target, displaying an image corresponding to acceleration or deceleration in the display area between the vehicle and the lead vehicle.

8. A display control method for displaying an image in a display area of a display unit showing a scene ahead of a vehicle or an image replicating the scene ahead, the method comprising, by a computer:
detecting a lead vehicle traveling ahead of the vehicle; and
based on an acceleration or deceleration of a specific value or greater occurring in the vehicle due to following cruise control with the lead vehicle as a follow target, displaying an image corresponding to acceleration or deceleration in the display area between the vehicle and the lead vehicle.
